(19) United States
(12) Patent Application Publication
(10) Pub. No.: US 2007/0095485 A1
(43) Pub. Date: May 3, 2007

(54) Method and system for constructing blinds/shades that allow air to flow through while blocking sunlight

(76) Inventor: Oran Joseph Bodner, Zichron Yaakov (IL)

Correspondence Address: ORAN JOSEPH BODNER, 2 HITTA ST., ZICHRON YAAKOV, 30900, IL

(21) Appl. No.: 11/163,766

(22) Filed: Oct. 29, 2005

(51) Int. Cl. E06B 9/26

(52) U.S. Cl. 160/166.1

(57) ABSTRACT

The present invention is designed to propose a new type of shade (or blind) that allows the user to independently control the amount of sunlight and air coming through, and suggests a number of methods for achieving this. Using this system, one can, for example, take an afternoon nap while blocking out all sunlight while letting in a gentle breeze.

Most shades are fairly good at blocking out sunlight, but as they do so they also block out the air, Often it is desirable to allow air to flow in and/or out while blocking out sunlight, for afternoon naps, for example.

Ideally, one should be able to control both the amount of sunlight and the amount of air coming through independently. Thus one can have all sunlight and no air (as in a closed glass window), all air and no sunlight, or any combination of the two (e.g. 30 percent sunlight and 90 percent air).

This invention proposes a system for achieving the above.

What is claimed is:

1. A system of blinds that allow one to control both the amount of light and the amount of air and the amount of light coming through, using a construction to achieve this goal.

2. The method of claim 1, wherein said blinds are vertical blinds.

3. The method of claim 1, wherein said blinds are horizontal blinds.

4. The method of claim 1, wherein said construction is one or more “breathable fabrics”.

5. The method of claim 1, wherein said construction is multiple layers of slats in an interlacing manner, where each layer obscures the light let though from the previous layer.

6. The method of claim 1, wherein said construction is a set of curved (e.g. “S”-shaped) slats with a non-reflective surface, that may allow the air to flow though almost freely (via a slightly curved route) while totally blocking sun rays.
